(19) United States
(12) Patent Application Publication
(10) Pub. No.: US 2010/0076823 A1
(43) Pub. Date: Mar. 25, 2010

(54) Voting system and method of voting

(76) Inventors: Yasha Feldman, Brooklyn, NY (US); Oleg Aharonov, Brooklyn, NY (US)

Correspondence Address: Ilya Zborovsky, 6 Schoolhouse Way, Dix Hills, NY, 11746, US

(21) Appl. No.: 12/284,529

(22) Filed: Sep. 24, 2008

(51) Int. Cl. G07C 13/00; G06F 3/041

(52) U.S. Cl. 705/12; 715/702

(57) ABSTRACT

A voting system has a monitor to be activated by a voting person, means for introducing a name of the voting person, a computer system connected with the monitor and the means and provided with a computer program configured so that on a screen of the monitor a plurality of icons are exhibited each corresponding to a person for who voting persons have to vote, and so that upon touching a corresponding one of the icons by the voting person an information that the voting person voted for a corresponding person to be voted for in correspondence with the touched icon is supplied to the computer system, where upon the computer program calculates votes and determines winners.

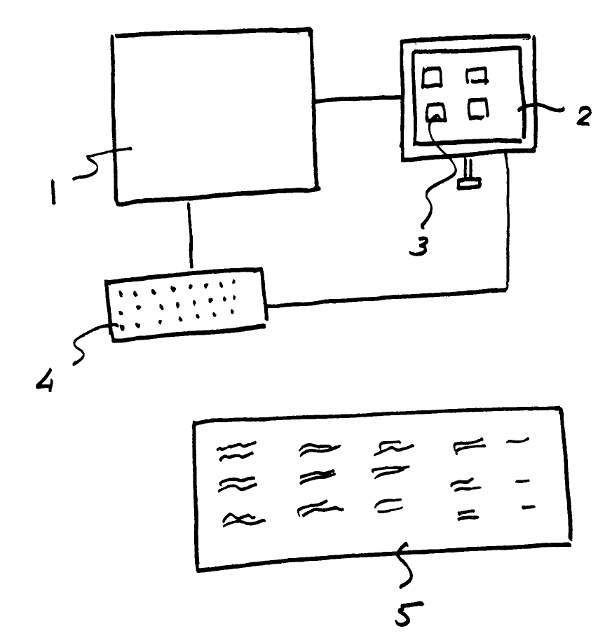

### BACKGROUND OF THE INVENTION

The present invention relates to a new system for and a method of voting, and is applicable for any election starting from presidential elections and including elections to local counsels as well as in other organizations when it is necessary to carry out voting.

There are many existing voting systems. It is believed that the existing systems can be further improved.

### SUMMARY OF THE INVENTION

Accordingly, it is an object of the present invention to provide a voting system and a method of voting, which are further improvements of existing methods.

In keeping with these objects and with others which will become apparent hereinafter, in a voting system, comprising a monitor to be activated by a voting person; means for introducing a name of the voting person; a computer system connected with said monitor and said means and provided with a computer program configured so that on a screen of said monitor a plurality of icons are exhibited each corresponding to a person for who voting persons have to vote, and so that upon touching a corresponding one of said icons by the voting person an information that the voting person voted for a corresponding person to be voted for in correspondence with the touched icon is supplied to the computer system, where upon the computer program calculates votes and determines winners.

Another feature of the present invention resides, briefly stated, in a method of voting, comprising a monitor by a voting person; introducing a name of the voting person by introducing means; connecting a computer system connected with said monitor and said means and provided with a computer program configured so that on a screen of said monitor a plurality of icons are exhibited each corresponding to a person for who voting persons have to vote, and so that upon touching a corresponding one of said icons by the voting person an information that the voting person voted for a corresponding person to be voted for in correspondence with the touched icon is supplied to the computer system, where upon the computer program calculates votes and determines winners.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

The single FIGURE of the drawings shows a new voting system which carries out a new inventive voting method in accordance with the present invention.

### DESCRIPTION OF THE PREFERRED EMBODIMENTS

The voting system and the voting method can be carried out in accordance with two different programs of variants.

The first program resides in the following.

The program is based on fingerprints. A corresponding computer program is introduced into a computer memory in a computer center 1 (for example central processing unit, etc.). The computer program can include a list of all candidates to be voted for, their belonging to corresponding parties, and their program of actions. A monitor 2 exhibits a plurality of icons 3 each corresponding to a respective candidate. In the icon the name of the candidate can be exhibited. The system and the method are configured so that when a voting person touches with his/her finger a corresponding one of the icons 3 the monitor 2 or the corresponding icon scans the fingerprint of the voting person and supplies the information to the computer center 1. Every candidate has his/her code, which is also connected with the computer program, so that every vote given for the corresponding candidate will is taken into account.

In accordance with the present invention, also lists of voting persons are introduced into the memory of the computer system as well.

In order to vote, a voting person can introduce, for example through a keyboard 4, his name, and then touch the corresponding icon of the respective candidate, for who he wants to give his vote. The computer counts the votes in correspondence with the computer program.

The system and the method also include an electronic screen 5 which can be placed in the voting facility. It is connected with the computer/computer center 1 so that it is possible to continuously monitor the process of voting, since the votes are processed in the computer memory of the computer sensor 1 and supplied to the electronic screen 5.

After the voting is finished, the computer momentarily produces data about the vote, in particular shows on the screen how many votes are given for a corresponding one of the candidates and who is the winner of the election.

The second program voting victory resides in the following.

This program operates only based on the fingerprints, and it is not necessary to have lists of voting people or belonging of candidates to different political parties. All candidates who participate in election are introduced into the computer memory, with their party affiliation, programs, etc. All candidates are continuously shown on the monitor, and near the name of each candidate there is an icon for voting. The icon scans a fingerprint of voting persons and introduces them into a computer memory. A voting person touches the icon of each candidate, for which he wants to vote. The icon scans his/her fingerprints and introduces it into the computer memory. In the computer memory, the votes are counted for the corresponding candidates. In this program similarly to the first program the data about the process of voting are continuously displayed on the electronic screen 5. After the end of the vote, on the electronic screen the results of the voting are presented, in particular how many votes are given for each candidate and who is a winner.

Both programs completely exclude a possibility of forging votes, it is not necessary to have monitors, there can be no controversy about the results of the vote. It is not necessary to have separate isolated cabins for voting people. The size of the voting facility can be very small just sufficient for installation of computer and electronic equipment.

The voting is performed completely confidentially, and the identities of the voting persons are for who they voted could not be establishes.

It will be understood that each of the elements described above, or two or more together, may also find a useful application in other types of methods and constructions differing from the type described above.

While the invention has been illustrated and described as embodied in a voting system and the method of voting, it is not intended to be limited to the details shown, since various modifications and structural changes may be made without departing in any way from the spirit of the present invention.

Without further analysis, the foregoing will so fully reveal the gist of the present invention that others can, be applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims:

1. A voting system, comprising a monitor to be activated by a voting person; means for introducing a name of the voting person; a computer system connected with said monitor and said means and provided with a computer program which when executed causes exhibiting on a screen of said monitor a plurality of icons each corresponding to a person for who voting persons have to vote, and so that upon touching a corresponding one of said icons by the voting person an information that the voting person voted for a corresponding person to be voted for in correspondence with the touched icon is supplied to the computer system, where upon the computer program calculates votes and determines winners.

2. A voting system as defined in claim 1; and further comprising an additional electronic screen connected with said computer system and continuously exhibited names of the persons for who voting persons voted with the numbers of votes received by them.

3. A voting system as defined in claim 2, wherein said electronic screen is operative for exhibiting a name of a winner of the voting as well.

4. The method of voting, comprising the steps of providing a monitor to be activated by a voting person; introducing a name of the person by introducing means connecting a computer system a said monitor and said means; providing in the computer system a computer program which when executed causes exhibiting on a screen of said monitor a plurality of icons each corresponding to a person for who voting persons have to vote; touching a corresponding one of said icons by the voting person so that an information that the voting person voted for a corresponding person to be voted for in correspondence with the touched icon is supplied to the computer system; calculating by the computer program votes and determining winners.

5. The method of voting as defined in claim 4; and further comprising, on an additional electronic screen connected with said computer system, continuously exhibiting names of the persons for who voting persons voted with the numbers of votes.

6. The method of voting as defined in claim 5, and further comprising exhibiting on said electronic screen a name of a winner of the voting as well.
